(19) United States
(12) Patent Application Publication
(10) Pub. No.: US 2023/0237410 A1
(43) Pub. Date: Jul. 27, 2023

(54) CARBON VALUATION SYSTEM AND METHOD

(71) Applicant: KOREA TECHNOLOGY FINANCE CORPORATION (KOTEC), Busan (KR)

(72) Inventors: Wanghee YOU, Seoul (KR); Jimin LEE, Seoul (KR); Sunhyung LIM, Bucheon-si (KR); Hayoung PARK, Busan (KR); Eunju KIM, Yongin-si (KR)

(21) Appl. No.: 18/008,949

(22) PCT Filed: May 28, 2021
(86) PCT No.: PCT/KR2021/006682

§ 371 Date: Dec. 7, 2022

(30) Foreign Application Priority Data
Jun. 18, 2020 (KR) 10-2020-0074460
Jan. 5, 2021 (KR) 10-2021-0000603

(51) Int. Cl. G06Q 10/0637; G06Q 30/0201; G06Q 30/0207

(52) U.S. Cl. CPC G06Q 10/06375; G06Q 30/0206; G06Q 30/0207

(57) ABSTRACT

The present invention provides a carbon value assessment (“carbon valuation”) system, which includes an information processing device that evaluates an amount of greenhouse gas (“GHG”) reduction expected to occur by a technology project in a currency value, on the basis of: estimated reduction of greenhouse gas (“estimated GHG reduction amount”) which is an amount of GHG reduction presumed to be induced by the technology project that is a target to be assessed; a calculation period of the GHG reduction during which the GHG reduction occurs due to the technology project; a discount rate that quantifies possible risks occurring in the technology project; and an emission permit price.

### FIELD OF INVENTION

The present relates to a carbon valuation system and method for assessment of a value of greenhouse gas reduction presumed to be induced by a technology project.

### BACKGROUND OF INVENTION

The current climate change is one of the most important problems that mankind must deal with worldwide. Accordingly, after the Paris Agreement went into effect in 2016, 121 countries joined the Climate Goal Upward Alliance after the Climate Summit in September 2019. Starting with adoption of 2050 carbon neutrality as a global agenda, the European Union firstly announced declaration of 2050 carbon neutrality in December 2019, and then, other major countries such as China, japan and Korea also declared carbon neutrality one after another.

In order to actively respond to climate change, global regulations will be strengthened and companies will change their business activities accordingly, whereby the global economic order will be changed.

The European Union and the United States have begun discussing the introduction of a carbon border tax in earnest, and the European Union has raised automobile emission regulations and is strengthening environmental regulations such as establishment of a new plastic tax. The carbon border tax is a system that imposes a tax when exporting goods from countries with weak greenhouse gas emission regulations to countries with strong regulations.

Further, major international organizations such as the International Monetary Fund (IMF) and the Bank for international Settlements (BIS) are also recommending a preemptive response, such as raising carbon taxes and establishing a climate change risk financial supervision and management system.

In the private sector, global companies' and financial companies' participation in RE100 and ESG (environmental-social-governance) investment are expanding, and environment-considering management activities such as limiting investment in environmentally unfriendly companies are spreading. RE100 is a voluntary campaign that 100% of the company's electricity will be supplied with renewable energy and, in recent years, about 260 companies have declared their participation. On the other hand, ESG is to evaluate non-financial factors such as contribution of a company on environment and society, transparency of management structure, etc. Currently, as a result of the GSIA survey, the global ESG-related investment scale increased from $18 trillion in 2014 to $23 trillion in 2016, and even to $30 trillion in 2018.

Meanwhile, the eco-friendly market is also growing, and major countries are expanding their investments to preoccupy new eco-friendly markets.

Renewable energy industries such as solar and wind power are gradually developing, the value of hydrogen is being highlighted, and the secondary battery market is also expected to grow rapidly due to the expandable distribution of electric vehicles.

Before and after the declaration of carbon neutrality, major countries announced large-scale green investments. The European Union agreed to invest 1 trillion euros over the next 10 years in the Green Deal, while US President-elect Biden agreed to invest 1.7 trillion dollars over the next 10 years.

Korea declared carbon neutrality in October 2019, and greenhouse gas emission is expected to decrease after the peak of 7277.6 million tons in 2018. However, the period remaining until carbon neutrality is only 32 years, which are relatively tighter than other countries (the European Union (60 years) and Japan (37 years)).

In the industrial structure, a proportion of the manufacturing industry and a high proportion of industries such as steel and petrochemicals that emit large amounts of carbon are also a limiting factor in achieving carbon neutrality early. Further, in an energy mix aspect, the importance of coal generation (40.4%) is higher than that of other countries (USA (24.0%), Japan (32.0%), Germany (30.0%)).

Under such circumstances, if the industrial, structure changes from high-carbon to low-carbon and renewable energy expands, the burden on the industry increases while competitiveness may weaken, simultaneously. Further, reduction in jobs due to weakening of existing industrial foundation such as thermal power generation, internal combustion engine, etc., and inflation such as raised public utilities including electric charges, heating costs, etc. are also a concern.

Considering the peculiarities of the economic and industrial structure of Korea, which is highly dependent on trade, changes are inevitable to respond to a new international order. This is because, in the case of a lukewarm response to carbon neutrality, investment in key industries and global sourcing opportunities are limited, which negatively affects exports, overseas financing, and corporate credit ratings, or the like. In particular, if the European Union or the United States introduce a carbon border tax, it is inevitable that major domestic industries such as petrochemicals and steel will suffer a significant blow.

In this trend, as a solution of promoting carbon neutrality and strengthening the institutional basis, a system and method for assessment or evaluation of carbon value would be required.

In this regard, the carbon value is an amount of greenhouse gas reduction estimated to be caused by the technology project, which is converted into a value amount. In the present invention, a method for assessment or evaluation of carbon value is proposed.

### SUMMARY OF INVENTION

### Technical Problem to be Solved

An object of the present invention is to provide a carbon value assessment system and method that can evaluate and calculate an amount of greenhouse gas reduction estimated to be induced by a technology project as a value amount, so as to be utilized for finance or the like.

### Technical Solution

In order to solve the above problems, on the basis of: estimated reduction of greenhouse gas (“estimated GHG reduction amount”) which is an amount of greenhouse gas (“GHG”) reduction presumed to be induced by a technology project that is a target to be assessed; a calculation period of the GHG reduction during which the GHG reduction occurs due to the technology project; a discount rate that quantifies possible risks occurring in the technology project; and an emission permit price, the present invention provides a carbon value assessment (“carbon valuation”) system including an information processing device that evaluates an amount of GHG reduction expected to occur through the above technology project in currency value.

According to an embodiment, the technology project refers to a business in which a subject of this business executes a GHG reduction project, otherwise, develops, produces, sells or services a GHG reduction product, wherein the GHG reduction project includes an activity for the subject of the technology project to directly generate GHG reduction effects, while the GHG reduction product includes a product or service to be provided for execution of the GHG reduction project so as to indirectly contribute to the GHG reduction. In this regard, an amount of GHG reduction by the GHG reduction product may be a reduction amount estimated while reflecting a contribution extent of the product to the GHG reduction amount by the GHG reduction project.

According to an embodiment, the information processing device evaluates a value of the GHG reduction amount according to the following equation,

$$Carbon value = {\sum }_{t = 1}^{n} \frac{\begin{matrix}estimated GHG reduction {amount}_{t} \times \\ emission permit price\end{matrix}}{{( 1 + r )}^{t}} \qquad [ Equation ]$$

wherein n is a GHG reduction calculation period, the estimated GHG reduction amount, is an estimated amount of GHG in t-th year, and r denotes the discount rate.

According to an embodiment, the information processing device may evaluate a value of the GHG reduction amount according to the following equation, additionally based on a technical contribution extent indicating contribution of key technology constituting the technology project to the GHG reduction.

$$Carbon value = {\sum }_{t = 1}^{n} \frac{\begin{matrix}estimated GHG reduction {amount}_{t} \times \\ emission permit price\end{matrix}}{{( 1 + r )}^{t}} \times technical contribution extent \qquad [ Equation ]$$

Wherein n may be an economic lifespan of the technology constituting the technology project, while r may be the discount rate.

According to an embodiment, the information processing device may calculate the estimated GHG reduction amount, on the basis of a difference between a baseline emission amount indicating a GHG emission amount according to an alternative scenario, which is most likely to occur if the technology project was not commercialized, and a target emission amount indicating a GHG emission amount caused by a commercialization of the technology project.

According to an embodiment, the information processing device may estimate each of the baseline emission amount and the target emission amount, respectively, by multiplying an activity amount to quantify a size of human activity causing GHG emission, an emission factor to quantify an GHG emission amount for unit activity, and a global warming potential, which is a numerical expression of information on the contribution of each greenhouse gas to global warming in terms of carbon dioxide.

According to an embodiment, the activity amount may be calculated from product sales (or sales amount), a production volume, a waste incineration amount or a product use amount by the subject of the technology project, wherein a change over time may be reflected.

According to an embodiment, the information processing device may calculate the estimated GHG reduction amount while reflecting a contribution extent of the GHG reduction product among an estimated annual GHG reduction amount in the project, to which the GHG reduction product is expected to be applied.

According to an embodiment, the emission permit price is a value received from an external emission permit trading server, which may be a price estimated on the basis of an evaluation reference date, an average price for a predetermined period, or a price for the predetermined period.

According to an embodiment, the emission permit price may be an average value of emission permit prices actually traded for 1 year from a start date to an end date of the previous year prior to a year, in which the evaluation reference date belongs, with weighting a trading volume.

Further, on the basis of: an estimated GHG reduction amount, which is an amount of GHG reduction presumed to be induced by a technology project that is a target to be assessed; a GHG reduction calculation period during which the GHG reduction occurs due to the technology project; a discount rate that quantifies possible risks occurring in the technology project; and an emission permit price, the present invention provides a carbon valuation method, which includes evaluating an amount of GHG reduction expected to occur through the above technology project in a currency value by means of an information processing device.

### Effect of Invention

The carbon valuation system and method according to the present invention may estimate and calculate an expected amount of GHG reduction presumed to be induced in a technology project as a value amount, thereby being effectively utilized for finance, or the like.

### BRIEF DESCRIPTION OF DRAWINGS

FIG. 1 is a step-by-step illustration of a process for evaluating a carbon value according to an embodiment of the present invention.

FIG. 2 is a diagram schematically illustrating an estimated GHG reduction amount, which is one of factors considered when evaluating the carbon value according to an embodiment of the present invention.

### DETAILED DESCRIPTION OF PREFERRED EMBODIMENTS OF INVENTION

Hereinafter, the embodiments disclosed in the present specification will be described in detail with reference to the accompanying drawings, but the same or similar components are assigned to the same reference numbers regardless of reference numerals, and redundant description thereof will be omitted. The suffixes “module” and “part” for the components used in the following description are given or mixed in consideration of only the ease of writing the specification, and do not have distinct meanings or roles by themselves. Further, with regard to the embodiments disclosed in the present specification, if it is determined that detailed descriptions of related known technologies may obscure the gist of the embodiments disclosed in this specification, the detailed description thereof will be omitted. In addition, the accompanying drawings are only for easy understanding of the embodiments disclosed in the present specification, however, the technical idea disclosed herein is not limited by the accompanying drawings and should be construed as including all changes, equivalents and substitutes included in the spirit and scope of the present invention.

When an element is referred to as being “coupled” or “connected” to another element, it is understood that it may be directly coupled or connected to the other element, or an alternative element may exist therebetween. On the other hand, when it is said that a certain element is “directly coupled” or “directly connected” to another element, it should be understood that an alternative element does not exist therebetween.

The singular expression may include the plural expression unless the context clearly dictates otherwise.

In this specification, terms such as “include” or “have” are intended to designate that the features, numbers, steps, operations, components, parts, or combinations thereof described in the specification exist, but it should be understood that this does not preclude the existence or addition of one or more other features, numbers, steps, operations, components, parts, or combinations thereof.

Carbon Valuation System

The carbon valuation system according to an embodiment of the present invention may include an information processing device that evaluates an amount of GHG reduction expected to occur in a technology project in currency value, on the basis of: an estimated GHG reduction amount, which is an amount of GHG reduction presumed to be induced by the technology project that is a target to be assessed; a calculation period of the GHG reduction during which the GHG reduction occurs due to the technology project; a discount rate that quantifies possible risks occurring in the technology project; and an emission permit price.

First, among the terms usec in this specification, the carbon value refers to a value obtained by converting the GHG reduction amount presumed to be induced by the technology project into a currency value, wherein the technology project indicates a business in which a subject of this business executes a GHG reduction project, or in which the subject develops, produces, sells or services GHG reduction products.

The information processing device is a device that executes various calculations or processing of different types of information for carbon valuation according to an embodiment of the present invention, and types of the above device are not particularly limited. For example, the above device may be implemented in the form of not only fixed terminals such as a digital TV or a desktop computer, but also portable terminals such as mobile phones, smart phones, laptop computers, digital broadcasting terminals, PDA (personal digital assistants), PMP (portable multimedia player), navigation, slate PC, tablet PC, ultrabook, etc.

That is, the information processing device may evaluate an amount of GHG reduction expected to occur through the technology project in a currency value, using an estimated reduction amount, an economic lifespan, a discount race and an emission permit price, so as to calculate the expected GHG reduction amount presumed to be induced in the technology project as a value amount, thereby being utilized in various fields such as finance.

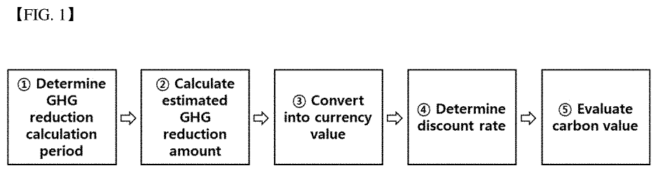

The GHG reduction calculation period refers to a period during which GHG reduction occurs due to the technology project as a tar-get to be assessed, while the estimated GHG reduction amount refers to an amount of future GHG reduction presumed to be induced by the technology project, which is estimated and calculated in a scenario mode. As shown in FIG. 1, first, the information processing device may determine the GHG reduction calculation period and calculate the estimated GHG reduction amount. Then, the information processing device may multiply the estimated GHG reduction amount by an emission permit price to convert it into a currency value, apply a discount rate thereto in order to make the converted currency value into the present value, followed by adding up the present value to which the discount rate is applied, thereby evaluating a carbon value thereof.

Specifically, when the information processing device evaluates a value of the GHG reduction amount, it may be based on Equation 1 below.

$$Carbon value = {\sum }_{t = 1}^{n} \frac{\begin{matrix}estimated GHG reduction {amount}_{t} \times \\ emission permit price\end{matrix}}{{( 1 + r )}^{t}} \qquad [ Equation 1 ]$$

Wherein n is a GHG reduction calculation period, the estimated GHG reduction amountₜ refers to an estimated amount of GHG reduction in t-th year, and r denotes a discount rate.

Factors to be considered in evaluating the carbon value by the information processing device may be divided into a case where the subject of the technology project executes a GHG reduction project and another case where the subject of the technology project produces and sells products (including services) that induce GHG reduction, and can be calculated differently.

In this regard, the concept of carbon value in a project refers to a reduction activity occurring direct GHG reduction, and may include, for example, a renewable energy power generation project. Further, the concept of carbon value in products (including services) refers to products that are used as a component of GHG activities (projects) and thus indirectly induce GHG reduction, and may include, for example, products for GHG reduction activities (projects) such as a solar cell, module, turbine, etc.

In other words, this means decomposing a project carbon value into carbon values of constitutional products for the project according to contribution of the reduction activities. In this regard, the GHG reduction contribution extent may be a ratio of unit prices or added values between products contributing to the GHG reduction. For example, assuming that the carbon value of the project is 100, product “g”, product “h” and product “I” may have carbon values of 50, 30 and 20, respectively.

1) If the Subject of the Technology Project Performs GHS Reduction Project

When evaluating the carbon value by the information processing device, one of the considered factors is the GHG reduction calculation period, which may be a period of annual units in comprehensive consideration of the legal, institutional, physical (or mechanical), technical, economic and social requirements necessary for normal implementation of the project.

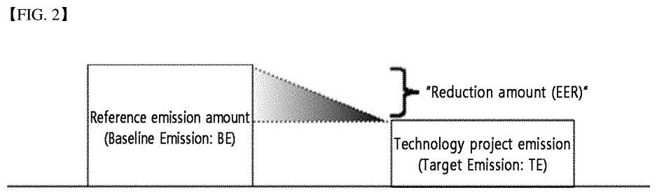

Further, when evaluating the carbon value by the information processing device, the estimated GHG reduction amount as one of the considered factors, as shown in FIG. 2, may be represented by a difference between a baseline emission amount (Baseline Emission: BE), which was calculated by assuming an alternative situation most likely to occur when the technology project to be assessed was not commercialized, and a target emission amount (Target Emission: TE), which was calculated by assuming a case where the technology project to be assessed has been commercialized.

GHG emission amounts at the baseline emission (BE) and the target emission (TE), respectively, may be calculated according to the following Equation 2,

GHG emission amount=amount of activity×emission factor×Global Warming Potential (GWP) [Equation 2]

Wherein the amount of activity indicates a size of human activities (fuel consumption, product usage, product sales, operation amount, productivity, waste incineration etc.) that lead to GHG emission, while the emission factor is a coefficient that quantifies the GHG emission amount (CO₂ emission/unit fuel consumption, calorific value, oxidation rate, enteric fermentation emission factor, biomass emission factor, methane correction factor, etc.). Further, GWP may represent an extent of contribution of each greenhouse gas to global warming in a numerical value in terms of carbon dioxide (see Table 1 below).

TABLE 1

| | carbon | | nitrous | | | sulfur |
|---|---|---|---|---|---|---|
| green | dioxide | methane | oxide | perfluorocarbon | hydrofluorocarbon | hexafluoride |
| gas | (CO₂) | (CH₄) | (N₂O) | (PFCs) | (HFCs) | (SF₆) |
| Global | 1 | 21 | 310 | 6,500~9,200 | 140~11,700 | 23,900 |
| Warming | | | | | | |
| Indices | | | | | | |

As described above, the estimated GHG reduction amount (EER) may be calculated using the target emission (TE) and the baseline emission (BE) calculated above. In this case, EER refers to an estimated GHG reduction amount presumed to occur in a process of commercialization of the technology project to be assessed, and may be calculated by subtracting TE from BE as shown in the following Equation 3.

Estimated GHG reduction amount (EER)ₜ=Baseline Emission (BE)ₜ−Target Emission (TE)ₜ [Equation 3]

Again, the emission permit price, as one of the factors considered when evaluating the carbon value by the information processing device, is used to convert the EER into a currency value, therefore, the carbon value may be calculated through conversion by multiplying the EER calculated as above for each year by the emission permit price (see the following Equation 4).

Currency value converted amount in t-th year=(EER)ₜ×(emission permit price) [Equation 4]

Wherein the emission permit price is a means for converting the EER (tCO₂-eq) into an amount (price), wherein it may be transaction price information provided by the emission permit trading exchange (KRX), a market in which emission permits are traded between independent parties. This is because the emission permit obtained by a company through GHG reduction is tradable in the market and best reflects the economic value of the GHG reduction amount.

That is, the information processing device may set the emission permit price based on the value received from an emission permit trading exchange server operated by the emission permit trading exchange.

The emission permit price is a transaction price provided by the emission permit trading exchange and, when evaluating a value of the estimated GHG reduction amount, it may be a price based on the corresponding evaluation reference date. However, the emission permit price is variable and, when considering the variability, an emission permit price to be considered when evaluating a carbon value may be an average price for a predetermined period, preferably the average of emission permit prices for the last 1 year. Alternatively, it may be a price estimated according to a trend due to price fluctuations, on the basis of prices over a predetermined period of time.

On the other hand, the discount rate, which is one of the factors considered when the carbon value is evaluated by the information processing device, is used for changing the converted currency value for the estimated GHG reduction amount into the present value. However, there is a close relationship between a technology project risk and a reduction occurring risk, therefore, if the technology project is not normally operated, there is high possibility that GHG reduction does not occur or GHG reduction amount may be reduced. Therefore, it is desirable to apply different risks inherent in a technology commercialization process to the discount rate when changing the estimated GHG reduction amount into the current price.

In other words, with regard to the carbon valuation according to an embodiment of the present invention, it is preferable to reflect a commercialization risk according to a commercialization subject, which is the same as in technology value assessment. Therefore, in the same manner as a discount rate calculation method used in the technology value assessment, the discount rate may be calculated using a capital asset pricing model (CAPM). However, it is preferable to additionally reflect factors affecting success/failure of commercialization of GHG reduction technologies (climate environment contribution, environmental and social impact, policy conformity, climate industry ripple effect, etc.) in the commercialization risk.

As a result, the information processing device may apply a discount rate to an annual currency value conversion amount obtained by multiplying the estimated GHG reduction amount by the emission permit price, thereby calculating a sum of the present value for each year (see Equation 1 above).

2) In a Case where the Subject of the Technology Project Produces or Sells Products Inducing GHG Reduction

When the information processing device calculates a value of the GHG reduction amount presumed to be induced by a corresponding technology project, if the subject of the technology project produces and sells products (including services) that induce GHG reduction, this is substantially the same as the case where the subject of the technology project performs GRG reduction project. However, among factors considered when the information processing device evaluates a carbon value, the GHG reduction calculation period, calculation of the estimated GHG reduction amount, application of the discount rate, etc. may vary according to product assessment characteristics.

Hereinafter, differences from the case where the subject of the aforementioned technology project implements GHG reduction project will be mainly explained.

With regard to the GHG reduction calculation period, which is one of the factors considered when the information processing device evaluates a carbon value, an economic lifespan of the key technology constituting a product as a target to be assessed may become the GHG reduction calculation period.

The economic lifespan refers to a period during which a technology project maintains a competitive advantage in the market, and may be not only a simple technology lifespan but also a period defined by considering environmental factors under which the corresponding technology is used.

Further, with regard to the estimated GHG reduction amount, which is one of factors considered when the information processing device evaluates a carbon value, a value summed with a reduction amount contributed by an evaluation target product among the estimated annual GHG reduction amount of a project, to which the evaluation target product is expected to be applied, may be used as the estimated GHG reduction amount induced by the product.

Further, the carbon value of a technology to which a technical contribution extent is applied may be evaluated by considering the contribution of a key technology constituting an evaluation target product. The technical contribution extent refers to a level, for contribution of the key technology constituting the evaluation target product to GHG reduction, and may be calculated by multiplying the estimated GHG reduction amount induced due to the product by the technical contribution extent.

Specifically, the information processing device may evaluate a value of the GHG reduction amount based on the technical contribution extent according to the following Equation 5.

$$Carbon value = {\sum }_{t = 1}^{n} \frac{\begin{matrix}estimated GHG reduction {amount}_{t} \times \\ emission permit price\end{matrix}}{{( 1 + r )}^{t}} \times technical contribution extent \qquad [ Equation 5 ]$$

Wherein n is an economic lifespan of the key technology, the estimated GHG reduction amountₜ is an estimated GHG reduction amount in t-th year, and r may be the discount rate.

Carbon Valuation Method

The carbon valuation method according to an embodiment of the present invention may include evaluating an amount of GHG reduction expected to occur through a technology project in a currency value by an information processing device, on the basis of: an estimated GHG reduction amount indicating an amount of GHG reduction presumed to be induced by the technology project that is a target to be assessed; a GHG reduction calculation period during which the GHG reduction occurs due to the technology project; a discount rate that quantifies possible risks occurring in the technology project; and an emission permit price.

Accordingly, the estimated GHG reduction amount presumed to be induced due to the technology project may be assessed and evaluated as a value amount, thereby being utilized for finance or the like.

Since the description of the above step overlaps with those described above, a detailed description thereof will be omitted while applying the afore-mentioned description.

Computer-Readable Recording Medium

The carbon valuation method according to an embodiment of the present invention described above may be implemented in the form of program instructions that can be executed through various computer components and recorded in a computer-readable recording medium. The computer-readable recording medium may be provided with program instructions, data tiles, data structures, etc. alone or in combination. The program instructions recorded on the computer-readable recording medium may be specially designed and configured for the present invention, or may be known and available to those skilled in the computer software field. Examples of the computer-readable recording medium may include magnetic media such as hard disks, floppy disks, and magnetic tapes, etc, optical recording media such as CD-ROMs and DVDs, magneto-optical media such as floptical disk, and hardware devices specially configured to store and execute program instructions, such as ROM, RAM, flash memory, and the like. Examples of the program instructions may include not only machine language codes such as those generated by a compiler, but also high-level language codes, that can be executed by a computer using an interpreter or the like. The hardware device may be configured to operate as one or more software modules for executing the processing according to the present invention, and vice versa.

As above, preferred embodiments of the present invention have been described in detail with reference to the drawings. The description of the present invention is for illustrative purposes, and those skilled in the art to which the present invention pertains will understand that it can be easily modified into other specific forms without changing the technical spirit or essential features of the present invention.

Accordingly, the scope of the present invention is indicated by the claims described below rather than the above detailed description, and all changes or modifications derived from the meaning, scope, and equivalent concept of the claims should be interpreted to be included in the scope of the present invention.

1. A carbon value assessment (“carbon valuation”) system, comprising an information processing device that evaluates an amount of greenhouse gas (“GHG”) reduction expected to occur through a technology project in a currency value, on the basis of: estimated reduction of greenhouse gas (“estimated GHG reduction amount”) which is an amount of GHG reduction presumed to be induced by the technology project that is a target to be assessed; a calculation period of the GHG reduction during which the GHG reduction occurs due to the technology project; a discount rate that quantifies possible risks occurring in the technology project; and an emission permit price.

2. The system according to claim 1, wherein the technology project refers to a business in which a subject of this business executes a GHG reduction project, otherwise, develops, produces, sells or services GHG reduction products,
wherein the GHG reduction project includes an activity for the subject of the technology project to directly generate GHG reduction effects,
while the GHG reduction products include a product or service to be provided for execution of the GHG reduction project so as to indirectly contribute to the GHG reduction, and
wherein an amount of GHG reduction by the GHG reduction product indicates a reduction amount estimated while reflecting an extent of contribution of the product to the GHG gas reduction amount by the GHG reduction project.

3. The system according to claim 1, wherein the information processing device evaluates a value of the GHG reduction according to the following equation,
$$Carbon value = {\sum }_{t = 1}^{n} \frac{\begin{matrix}estimated GHG reduction {amount}_{t} \times \\ emission permit price\end{matrix}}{{( 1 + r )}^{t}} \qquad [ Equation ]$$
wherein n is a GHG reduction calculation period, the estimated GHG reduction amountₜ is an estimated amount of GHG reduction in t-th year, and r denotes the discount rate.

4. The system according to claim 3, wherein the information processing device evaluates the value of the GHG reduction amount according to the following equation, additionally based on a technical contribution extent indicating the contribution of a key technology constituting the technology project to the GHG reduction,
$$Carbon value = {\sum }_{t = 1}^{n} \frac{\begin{matrix}estimated GHG reduction {amount}_{t} \times \\ emission permit price\end{matrix}}{{( 1 + r )}^{t}} \times technical contribution extent \qquad [ Equation ]$$
wherein n is an economic lifespan of the technology constituting the technology project, while r denotes the discount rate.

5. The system according to claim 1, wherein the information processing device calculates the estimated GHG reduction amount, on the basis of a difference between a baseline emission amount indicating a GHG emission amount according to an alternative scenario, which is most likely to occur if the technology project was not commercialized, and a target emission amount indicating a GHG emission amount caused due to a commercialization of the technology project.

6. The system according to claim 5, wherein the information processing device estimates each of the baseline emission amount and the target emission amount, respectively, by multiplying an activity amount to quantify a size of human activity causing GHG emission, an emission factor to quantify a GHG emission amount for unit activity, and a global warming potential, which is a numerical expression of information on contribution of each greenhouse gas to global warming in terms of carbon dioxide.

7. The system according to claim 6, wherein the activity amount is calculated from product sales (or sales amount), a production volume, a waste incineration amount or a product use amount by the subject of the technology project, wherein a change over time is reflected.

9. The system according to claim 5, wherein the information processing device calculates the estimated GHG reduction amount while reflecting a contribution extent of the GHG reduction product among an estimated annual GHG reduction amount in the project, to which the GHG reduction product is expected to be applied.

9. The system according to claim 1, wherein the emission permit price is a value received from an external emission permit trading server, which is a price estimated on the basis of an evaluation reference date, an average price for a predetermined period, or a price for the predetermined period.

10. The system according to claim 9, wherein the emission permit price is an average value of emission permit prices actually traded for 1 year from a start date to an end date of the previous year prior to a year, in which the evaluation reference date belongs, with weighting a trading volume.

11. A carbon valuation method, comprising:
evaluating an amount of greenhouse gas (“GHG”) reduction expected to occur through a technology project in a currency value by means of an information processing device, on the basis of: estimated reduction of greenhouse gas (“estimated GHG reduction amount”) which is an amount of GHG reduction presumed to be induced by the technology project that is a target to be assessed; a calculation period of the GHG reduction during which the GHG reduction occurs due to the technology project; a discount rate that quantifies possible risks occurring in the technology project; and an emission permit price.
